(19) United States
(12) Patent Application Publication
(10) Pub. No.: US 2019/0277231 A1
(43) Pub. Date: Sep. 12, 2019

(54) MECHANISM FOR PREVENTING FIXATION OF CARBURETOR DUE TO RESIDUAL FUEL, AND CARBURETOR AND MOTOR INCLUDING THE SAME

(71) Applicant: Masakatsu KONO, Hanyu (JP)

(72) Inventor: Masakatsu KONO, Hanyu (JP)

(21) Appl. No.: 16/345,886

(22) PCT Filed: Jan. 18, 2018
(86) PCT No.: PCT/JP2018/001343

§ 371 Date: Apr. 29, 2019

(30) Foreign Application Priority Data
Feb. 22, 2017 (JP) 2017-031411
Nov. 10, 2017 (JP) 2017-216974

(51) Int. Cl. F02M 37/00; F02M 5/10; F02M 5/12

(52) U.S. Cl. CPC F02M 37/0011; F02M 37/0047; F02M 5/12; F02M 5/10

(57) ABSTRACT

An auxiliary chamber capable of changing its volume within a given range is provided separately from a fuel tank. The auxiliary chamber and a float chamber of a carburetor are communicated with each other. Fuel in the float chamber is sucked and temporarily evacuated, as needed, by increasing the volume of the auxiliary chamber, and the temporarily evacuated fuel is returned into the float chamber, as needed, by decreasing the volume of the auxiliary chamber. This prevents fixation of a carburetor due to residual fuel.

### CROSS-REFERENCE TO RELATED APPLICATIONS

This application is a U.S. National Phase Application of International Application No. PCT/JP2018/001343, filed on Jan. 18, 2018, which claims priority to Japanese Application No. 2017-031411, filed on Feb. 22, 2017 and Japanese Application No. 2017-216974, filed on Nov. 10, 2017. The entire disclosures of the above applications are incorporated herein by reference.

### BACKGROUND

### Technical Field

The present invention relates to a technical field of internal combustion engines, and more particularly relates to a technical field of internal combustion engines including a carburetor.

### Related Art

At present, carburetors are widely used in so-called small gasoline engines (internal combustion engines) such as in power generators, lawn mowers, and tillers.

Since a carburetor is necessarily disposed near a combustion chamber because of its structure, fuel stored in the carburetor (in a float chamber) for carburation has a high temperature. Such high temperature fuel causes no problem when the fuel is directly vaporized and used as fuel. Gasoline remaining in the carburetor when the engine is stopped, however, has been altered. If the altered gasoline is left as it is in the carburetor, the altered gasoline may jam a jet unit, thus making it difficult to restart the engine.

In order to solve such a problem, various inventions have been proposed in conventional techniques. For example, an invention for returning fuel remaining in a carburetor after engine stop to a fuel tank with pumps (an electrically powered pump and a manually operated pump) has been proposed (see Japanese Patent Application Laid-Open No. 2014-152606).

Moreover, an invention for returning residual fuel in a float chamber to a fuel tank by utilizing a negative pressure generated by engine stop has been proposed (see Japanese Patent Application Laid-Open No. Hei. 8-88247).

Furthermore, an invention for sucking residual fuel by utilizing capillary action and releasing the sucked residual fuel into the atmosphere has been proposed (see Japanese Patent Application Laid-Open No. 2005-240788).

Returning the altered residual fuel to the fuel tank as in the inventions described in Japanese Patent Application Laid-Open No. 2014-152606 and Japanese Patent Application Laid-Open No. Hei. 8-88247 is not desirable because it leads to the deterioration of the fuel quality of the entire fuel tank, although it is reduced.

When a pump is used as in the invention described in Japanese Patent Application Laid-Open No. 2014-152606, however, a valve mechanism included in the pump may be fixed due to altered gasoline and the pump itself may fail to function (in the invention described in Japanese Patent Application Laid-Open No. 2014-152606, the electrically powered pump and the manually operated pump are arranged in parallel as if such a possibility is implied).

When a negative pressure generated by engine stop is utilized as in the invention described in Japanese Patent Application Laid-Open No. Hei. 8-88247, fuel in a float chamber is not always returned to a fuel tank efficiently and there is a case where altered fuel remains in the float chamber.

Positively opening into the atmosphere, as in the invention described in Japanese Patent Application Laid-Open No. 2005-240788, means discarding still-usable fuel (although the discarded amount is small), thus wasting resources and creating an uneconomical condition. Furthermore, the capillary tube itself may clog due to altered fuel and fail to function.

In view of such circumstances, it is an object of the present invention to provide a mechanism capable of extracting residual fuel in a float chamber reliably and temporarily without returning the residual fuel to a fuel tank and while keeping a reusable condition and thus preventing fixation of a carburetor due to the residual fuel, and a carburetor or an internal combustion engine including such a mechanism.

### SUMMARY OF THE INVENTION

According to an aspect of the present invention, in order to solve the aforementioned problem, an auxiliary chamber capable of changing its volume within a given range is provided separately from a fuel tank. The auxiliary chamber and a float chamber of a carburetor are communicated with each other. Fuel in the float chamber can be sucked and temporarily evacuated, as needed, by increasing the volume of the auxiliary chamber, and the temporarily evacuated fuel can be returned into the float chamber, as needed, by decreasing the volume of the auxiliary chamber.

The employment of such a configuration enables altered residual fuel to be temporarily extracted from the float chamber without returning the altered residual fuel to the fuel tank. Moreover, since a negative pressure generated by changing the volume of the auxiliary chamber is utilized, the residual fuel can be reliably extracted from the float chamber.

Further, a structure for preventing an incorrect operation is further provided. The structure includes an operation unit configured to change the volume of the auxiliary chamber, the operation unit changing the position in accordance with a change in the volume of the auxiliary chamber. The operation unit is mechanically coupled to a fuel cock configured to control supply of fuel from the fuel tank to the carburetor. The fuel cock can be opened and the fuel can thus be fed into the float chamber from the fuel tank only while the operation unit is at a position to decrease the volume of the auxiliary chamber and thus return the fuel to the float chamber.

Further, the mechanism for preventing an incorrect operation is further characterized in that the fuel in the float chamber can be introduced into the auxiliary chamber by operating the operation unit only in a state in which the fuel cock is closed.

Further, the fuel cock configured to control the supply of the fuel from the fuel tank to the carburetor is of a negative pressure type in which the supply of the fuel is controlled by a negative pressure, and a negative pressure transmission pipe configured to communicate the fuel cock and the intake pipe of the internal combustion engine with each other is provided.

The employment of such a configuration can temporarily extract the altered residual fuel from the float chamber without returning to the fuel tank. In addition, since the fuel in the float chamber is sucked to the auxiliary chamber by utilizing the negative pressure generated by changing the volume of the auxiliary chamber, the residual fuel can be reliably extracted from the float chamber. Further, the negative pressure type fuel cock is adopted, and the fuel cock and the intake pipe are communicated with each other by the negative pressure transmission pipe. That is, the configuration is such that the fuel cock is opened and the fuel is supplied to the float chamber when the negative pressure is generated in the intake pipe (in the state in which the internal combustion engine is being driven), and the fuel cock is closed and the supply of the fuel to the float chamber is stopped when the negative pressure is not generated in the intake pipe (in the state in which the internal combustion engine is not driven). In short, since the supply of the fuel to the float chamber is automatically stopped when the internal combustion engine stops, it is possible to prevent the fuel from being further supplied to the float chamber after the residual fuel in the float chamber is transferred into the auxiliary chamber after the internal combustion engine stops. Similarly, since the auxiliary chamber is formed not as a separate chamber but, for example, integrally formed with the float chamber in such a manner as to extend the float chamber downward, a simpler and more compact configuration of the mechanism is possible.

Furthermore, a mechanism for blocking a negative pressure is provided. The mechanism includes an operation unit configured to change the volume of the auxiliary chamber, the operation unit changing the position in accordance with a change in the volume of the auxiliary chamber. An atmosphere release valve capable of communicating the inside and the outside of the negative pressure transmission pipe is provided along the negative pressure transmission pipe. The operation unit is mechanically coupled to the atmosphere open valve. The mechanism for blocking a negative pressure is capable of transmitting a negative pressure generated in the intake pipe to the fuel cock via the negative pressure transmission pipe while the atmosphere release valve is closed when the position of the operation unit is at a first position where the fuel is present in the float chamber by reducing the volume of the auxiliary chamber; and blocking a negative pressure generated in the intake pipe to the extent that the fuel cock is closed when the atmospheric open valve is opened at a second position where the fuel is evacuated from the float chamber while the volume of the auxiliary chamber is increased.

Such a configuration can automatically block the negative pressure of the negative pressure transmission pipe by operating the operation unit of the auxiliary chamber and close the fuel cock. That is, when the operation unit is at the first position (when the fuel is present in the float chamber), the negative pressure in the negative pressure transmission pipe transmitted from the intake pipe is transmitted to the fuel cock without any obstacle, so that the fuel cock is opened and the fuel is supplied to the float chamber. On the other hand, when the operation unit is at the second position (when the fuel is not in the float chamber), the negative pressure in the negative pressure transmission pipe is blocked by the inflow of the atmosphere from the atmosphere release valve. That is, the fuel cock is closed, and the fuel supply to the float chamber is stopped. Therefore, even if the operation unit of the auxiliary chamber is operated (the operation for transferring the fuel of the float chamber to the auxiliary chamber) in a state in which the internal combustion engine is not stopped (a state in which the internal combustion engine is being driven), the fuel can be reliably prevented from being continuously supplied to the float chamber. Further, since the supply of the fuel itself is stopped by the operation of the operation unit, the mechanism can serve also as a mechanism for stopping the internal combustion engine.

In addition, a change point at which the opening and closing of the fuel cock changes is provided in the middle of the transition of the operation unit from the first position to the second position, and a delay unit configured to delay the time during which the operation unit shifts from the change point to the second position is provided.

In this manner, it (the opening of the atmosphere open valve) is adjusted so as to change the opening and closing of the fuel cock in the middle of the transition of the operation unit from the first position to the second position. Thus, the fuel is more reliably prevented from being supplied to the float chamber after the residual fuel is evacuated to the auxiliary chamber, and the fuel is prevented from overflowing from the float chamber when the fuel evacuated to the auxiliary chamber is returned to the float chamber at the time of restart. In addition, providing the delay unit can transfer the fuel which can be supplied until the position of the operation unit reaches the change point to the auxiliary chamber more efficiently.

The delay unit is realized by setting the change point as close as possible to the first position.

Such a configuration can configure the delay unit without separately providing any other part or mechanism. That is, since “the change point is close to the first position” means that “the change point is far from the second position” at the same time, the delay unit is constituted by this physical distance.

In addition, the delay unit is realized by providing a guide unit configured to guide a movement of the operation unit at the time of transition from the first position to the second position, and configuring a shape guided by the guide unit in a crank shape or a hook shape in the middle of transition of the operation unit from the change point to the second position.

With such a configuration, the operation needs to be moved in a crank-like or hook-like manner when the operation unit is operated from the change point to the second position, so that the operation is delayed by the time required for this movement.

Further, the delay unit is realized by making the operation load on the operation unit from the change point to the second position larger than the operation load on the operation unit from the first position to the change point.

Such a configuration can realize the delay unit while the operation itself of the operation unit remains simple. Further, variable load enables the adjustment of the delay time according to the operator.

From a different perspective, the present invention can be viewed as a carburetor or an internal combustion engine including the mechanism for preventing fixation of a carburetor.

### Advantageous Effects of Invention

The application of the present invention enables the provision of the mechanism capable of extracting the residual fuel in the float chamber reliably and temporarily without returning the residual fuel to the fuel tank and while keeping the reusable condition and thus preventing fixation of the carburetor due to the residual fuel, and the carburetor or the internal combustion engine including such a mechanism.

### BRIEF DESCRIPTION OF THE DRAWINGS

FIG. 1 is a schematic configuration diagram of a mechanism for preventing fixation of a carburetor according to an exemplary embodiment of the present invention, illustrating a state in which fuel is evacuated into an auxiliary chamber (fuel cock is closed).

FIG. 2 is a schematic configuration diagram of the mechanism for preventing fixation of a carburetor according to the exemplary embodiment of the present invention, illustrating a state in which the fuel is pushed out into the float chamber from the auxiliary chamber (the fuel cock is closed).

FIG. 3 is a schematic configuration diagram of the mechanism for preventing fixation of a carburetor according to the exemplary embodiment of the present invention, illustrating a state in which the fuel cock is opened after pushing out the fuel into the float chamber from the auxiliary chamber.

FIG. 4 is a schematic configuration diagram of the auxiliary chamber and a structure for preventing an incorrect operation.

FIG. 5 is a schematic configuration diagram of a mechanism for preventing fixation of a carburetor integrally formed with a float chamber according to a second embodiment of the present invention.

FIGS. 6A-C are diagrams illustrating configuration examples of a displaceable film (diaphragm) constituting an auxiliary chamber.

FIG. 7 is a schematic configuration diagram of a mechanism for preventing fixation of a carburetor according to an exemplary embodiment of the present invention, illustrating a state in which fuel is present in the float chamber.

FIG. 8 is a schematic configuration diagram of the mechanism for preventing fixation of a carburetor according to the exemplary embodiment of the present invention, illustrating a state in which fuel is present in an auxiliary chamber.

FIG. 9 is a schematic configuration diagram of a mechanism for preventing fixation of a carburetor provided with an atmosphere open valve according to a second embodiment, illustrating a state in which fuel is present in a float chamber (atmosphere open valve closed).

FIG. 10 is a schematic configuration diagram of the mechanism for preventing fixation of a carburetor provided with the atmosphere open valve according to the second embodiment, illustrating a state in which fuel is present in an auxiliary chamber (atmosphere open valve opened).

FIG. 11 is a schematic configuration diagram illustrating a configuration example of a delay unit.

### DETAILED DESCRIPTION OF THE PREFERRED EMBODIMENTS

A mechanism 100 for preventing fixation of a carburetor according to an exemplary embodiment of the present invention will be described below with reference to the accompanying drawings. It is noted that sizes or dimensions of elements are partially shown in an exaggerated manner for ease of understanding the drawings and therefore do not necessarily correspond to those of an actual product. The drawings should be viewed in a direction of reference numerals. The upper, lower, left, right, front, and back sides are expressed on the basis of such a direction.

### Configuration of Mechanism 100 for Preventing Fixation of Carburetor

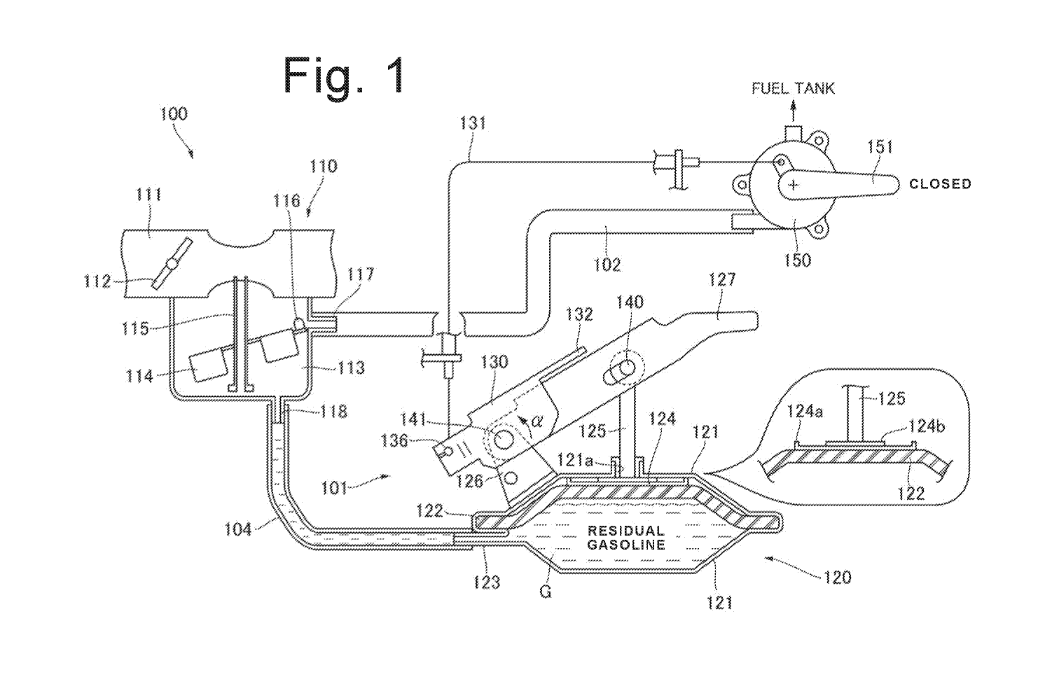

As shown in FIGS. 1 to 3, the mechanism 100 for preventing fixation of a carburetor, which is illustrated as an exemplary embodiment of the present invention, functions with an auxiliary chamber 120 connected to a carburetor 110 being used as a main component. Although not illustrated in the figures, the carburetor 110 and the auxiliary chamber 120 are included in an internal combustion engine.

The carburetor 110 is provided along an air passage 111 through which intake air passes from an air cleaner (not shown) to a combustion chamber (not shown). A throttle 112 is provided in the air passage 111. The carburetor 110 is configured such that a float chamber 113 including a float 114 is attached below the air passage 111. Part of the air passage 111 has a venturi portion having a reduced diameter. A jet needle 115 extending from the float chamber 113 is disposed in such a manner that its head pierces through the venturi portion. An upper portion of a side surface of the float chamber 113 is provided with a float chamber fuel feed port 117. A fuel cock 150 is connected to the float chamber fuel feed port 117. The fuel cock 150 is connected to the float chamber 113 by a fuel pipe 102. The fuel cock 150 is also connected to a fuel tank (not shown). In other words, when the fuel cock 150 is opened, fuel flows into the float chamber 113 via the fuel pipe 102. When an appropriate amount of the fuel is accumulated in the float chamber 113, a valve 116 included in the float 114 blocks the float chamber fuel feed port 117 to stop the inflow of the fuel.

A float chamber fuel evacuation port 118 is provided at a bottom surface of the float chamber 113. A fuel pipe 104 is connected to the float chamber fuel evacuation port 118, and the other end of the fuel pipe 104 is connected to a connection port 123 of the auxiliary chamber 120.

The auxiliary chamber 120 is provided with what is called a displaceable film (diaphragm) 122 and capable of changing its volume by operations of the displaceable film 122. The exterior of the auxiliary chamber 120 is formed by a casing 121 having suitable stiffness, and residual fuel G can be introduced into the casing 121. The displaceable film 122 is included in the casing 121. An outer periphery of the displaceable film 122 is secured to the casing 121. A portion of the displaceable film 122 excluding the outer periphery, on the other hand, is not secured to the casing 121, and is therefore capable of displacement in a vertical direction. In other words, the inside of the casing 121 is separated into upper and lower two chambers by the displaceable film 122. The lower chamber is provided with the connection port 123 and communicated with the float chamber 113 via the fuel pipe 124.

A through hole 121a is provided at an approximately center of an upper surface of the casing 121, and a bias rod 125 is passed through the through hole 121a. A bias plate 124 is attached to a lower end of the bias rod 125. The bias plate 124 is further secured to the displaceable film 122 by bonding. In other words, when the bias rod 125 moves up and down, the displaceable film 122 is displaced up and down accordingly.

An upper end of the bias rod 125 is connected to an approximate center of an operation lever 127 via a pin 140. One end of the operation lever 127 is pivotally supported by a pivot support base 126 secured to the casing 121 via a pin 141. In other words, when the operation lever 127 is pushed upward, the displaceable film 122 is raised via the bias rod 125, thus increasing the volume of the auxiliary chamber 120. When the operation lever 127 is pushed downward, on the other hand, the displaceable film 122 is lowered via the bias rod 125, thus decreasing the volume of the auxiliary chamber 120. In this case, it is also possible to adopt a configuration in which a small space is provided between the displaceable film 122 and the casing 121 even when the displaceable film 122 is lowered. This can prevent fixation (fixation between the displaceable film 122 and the casing 121) due to altered gasoline.

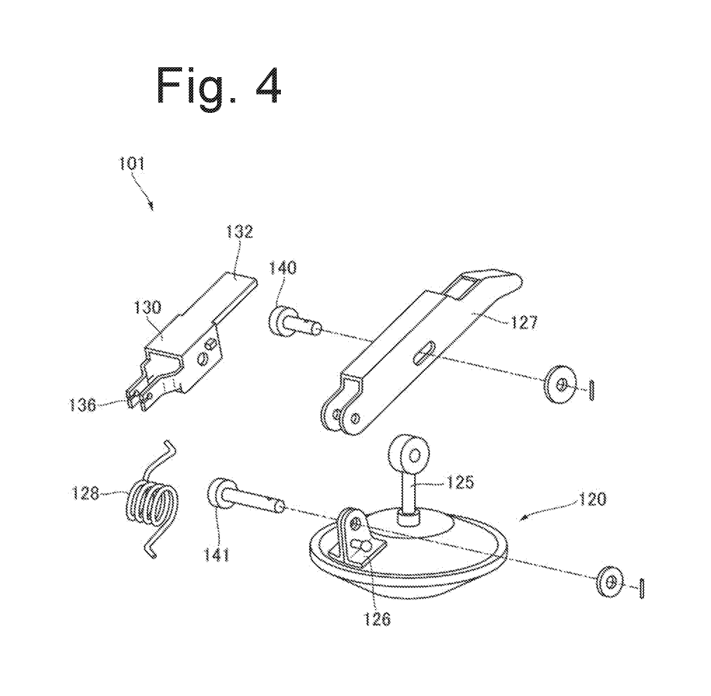

A lock member 130 is attached to the pivot support base 126 so as to cover the operation lever 127 (see also FIG. 4). The lock member 130 is also pivotally supported by the pivot support base 126 via the pin 141. One end of the lock member 130 across the pin 141 is provided with a wire attachment 136 to which a wire 131 is attached. The other end of the lock member 130 across the pin 141, on the other hand, includes an extended limiting plate 132. The lock member 130 is always biased by a spring 128 in a direction in which the wire 131 attached to the wire attachment 136 is pulled. The wire 131 attached to the lock member 130 is connected to a lever 151 of the fuel cock 150.

Thus, when the operation lever 127 is raised (when the residual fuel G is evacuated into the auxiliary chamber 120), the limiting plate 132 abuts against the upper surface of the operation lever 127, thereby preventing the movement of the lock member 130 (the lock member 130 cannot move when the wire attachment 136 is in a lowered state). Thus, the fuel cock 150 cannot be opened.

### Effects and Functions of Mechanism 100 for Preventing Fixation of Carburetor

On the basis of the assumption that the previously-used residual fuel G in the float chamber 113 has been evacuated into the auxiliary chamber 120, operations will be sequentially described.

Operation Procedure when Internal Combustion Engine is Started

To start the internal combustion engine, the fuel cock 150 needs to be opened. When the operation lever 127 is raised (when the previous residual fuel G is evacuated into the evacuation chamber 120), however, the pivot of the lock member 130 connected to the fuel cock 150 via the wire 131 is limited. Thus, the wire 131 cannot be pulled, and the fuel cock 150 therefore cannot be opened.

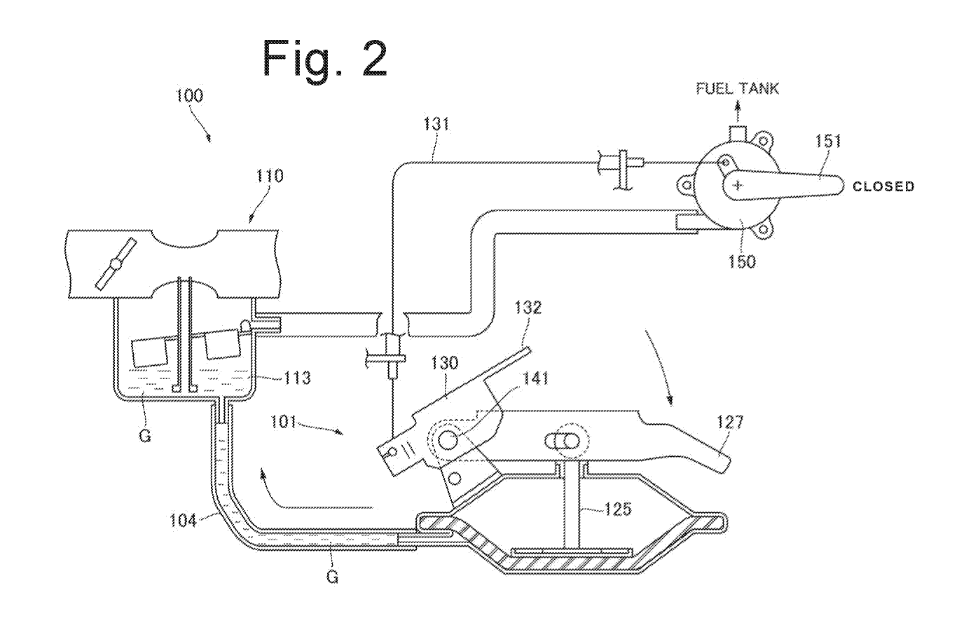

In view of this, the operation lever 127 of the auxiliary chamber 120 needs to be pushed downward before opening the fuel cock 150 as shown in FIG. 2, thereby pushing out the previous residual fuel G in the auxiliary chamber 120 toward the float chamber 113.

Only after such an operation, the lock member 130 can pivot about the pin 141 (pivot in a direction in which the limiting plate 132 abuts against the upper surface of the lowered operation lever 127).

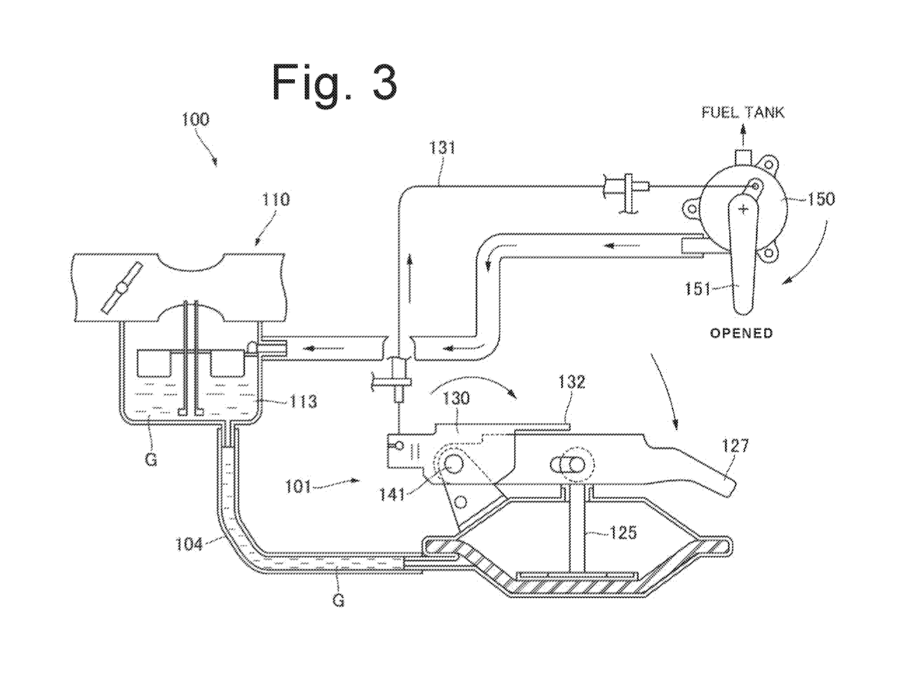

Thereafter, when the fuel cock 150 is opened as shown in FIG. 3, the fuel in the fuel tank flows into the float chamber 113 by a necessary amount, thereby enabling the start of the engine. This can completely prevent an incorrect operation such that the fuel cock 150 is opened while the previous residual fuel G remains in the auxiliary chamber 120.

Operation Procedure when Internal Combustion Engine is Stopped

An operation for evacuating the residual fuel G in the float chamber 113 into the auxiliary chamber 120 after the internal combustion engine is stopped will be described next.

As shown in FIG. 3, when the internal combustion engine is stopped, the fuel cock 150 is opened, the displaceable film 122 in the auxiliary chamber 120 is lowered (the volume of the auxiliary chamber 120 is decreased), and unvaporized residual fuel remains in the float chamber 113.

In this case, the residual fuel G is to be evacuated into the auxiliary chamber 120. If the fuel is evacuated into the auxiliary chamber 120 before closing the fuel cock 150 due to an incorrect operation, however, new fuel is further fed into the float chamber 113 from the fuel tank in order to replenish an amount of fuel reduced in the float chamber 113. In this case, the fuel overflows in the float chamber 113, and thus an operation for withdrawing the fuel, for example, needs to be performed separately in some way.

According to the present invention, however, when the fuel cock 150 is in an opened state, the limiting plate 132 of the lock member 130 has been moved in a direction along the operation lever 127 (see FIG. 3). The presence of such a limiting plate 132 prevents the operation lever 127 from being raised by itself. Thus, the fuel cock 150 needs to be closed first. When the fuel cock 150 is closed, force pulling the lock member 130 by the wire 131 is diminished. Due to the action of the spring 128, the limiting plate 132 of the lock member 130 pivots in a direction moving away from the operation lever 127 (the state as shown in FIG. 2 is obtained). Such a state allows the operation lever 127 to be raised, and the residual fuel in the float chamber 113 can therefore be introduced into the auxiliary chamber 120.

As just described, the present invention employs the configuration in which: the auxiliary chamber 120 capable of changing its volume within a given range is provided separately from the fuel tank; the auxiliary chamber 120 and the float chamber 113 of the carburetor 110 are communicated with each other; the residual fuel G in the float chamber 113 can be sucked and temporarily evacuated into the auxiliary chamber 120, as needed, by increasing the volume of the auxiliary chamber 120; and the temporarily evacuated residual fuel G can be returned into the float chamber 113, as needed, by decreasing the volume of the auxiliary chamber 120.

Thus, no altered residual fuel G needs to be returned to the fuel tank, thereby preventing deterioration in the quality of the fuel in the whole fuel tank. Moreover, since a negative pressure generated by changing the volume of the auxiliary chamber 120 is utilized without employing a valve mechanism such as a pump, the residual fuel G can be reliably extracted (sucked) from the float chamber 113.

An amount of change in the volume of the auxiliary chamber 120 is set to be larger than an appropriate volume of the fuel fed into the float chamber 113, thus allowing all residual fuel G in the float chamber 113 to be transferred into the auxiliary chamber 120.

Moreover, the auxiliary chamber 120 is configured to include the displaceable film 122 and change its volume by displacement of the displaceable film 122. This can reliably change the volume of the auxiliary chamber 120 with the simple structure.

There is further provided a structure 101 for preventing an incorrect operation in which: the operation lever 127, a position of which changes in accordance with a change in the volume of the auxiliary chamber 120, is provided; the operation lever 127 is mechanically coupled to the fuel cock 150 configured to control fuel supply from the fuel tank to the carburetor 110 with the wire 131; and the fuel cock 150 can be opened and the fuel can be thus fed into the float chamber 113 from the fuel tank only while the operation lever 127 is at the position to decrease the volume of the auxiliary chamber 120 and thus return the fuel to the float chamber 113.

With such a structure 101 for preventing an incorrect operation, it is mechanistically impossible to start the engine directly when an operator forgets that the residual fuel G has been evacuated into the auxiliary chamber 120. Thus, the previous residual fuel G evacuated into the auxiliary chamber 120 can be used preferentially and reliably. Moreover, no residual fuel G is left as it is in the auxiliary chamber 120 for a long period of time beyond an unused period of the engine.

### Other Configuration Examples

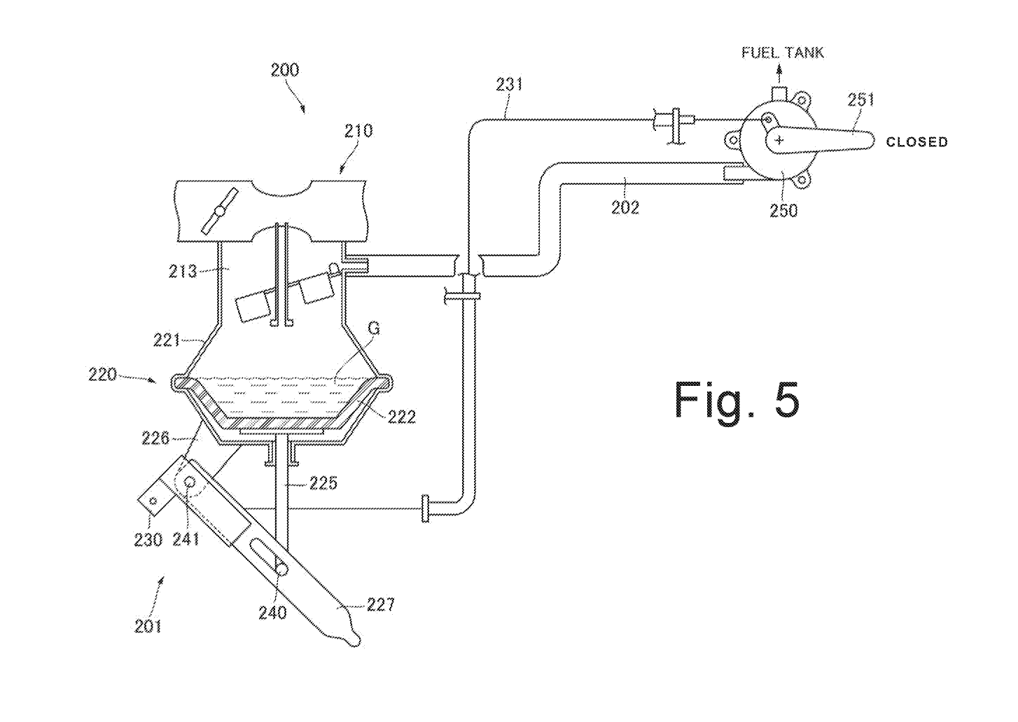

As shown in FIG. 5, it is also possible to implement a mechanism 200 for preventing fixation of a carburetor by integrally forming an auxiliary chamber 220 and a float chamber 213. More specifically, the auxiliary chamber 220 is provided below the float chamber 213 (as compared to the above-described embodiment, the auxiliary chamber is integrally formed upside down), and residual fuel G in the float chamber 213 is transferred into the auxiliary chamber 220 by lowering a displaceable film 222.

The auxiliary chamber 220 is formed not as a separate chamber but integrally with the float chamber 213 in such a manner as to extend the float chamber 213 downward. Consequently, similar effects (to those of the above-described mechanism 100 for preventing fixation of a carburetor) can be obtained, and a simpler and more compact configuration can be achieved also as a mechanism. Note that elements same as or similar to those in the above-described embodiment (the mechanism 100 for preventing fixation of a carburetor (in addition to the above-described mechanism 100 for preventing fixation of a carburetor)) are denoted by the same reference numerals in the last two digits and any redundant description will be omitted.

While the example in which the displaceable film (diaphragm) is used to change the volume of the auxiliary chamber has been described above, the auxiliary chamber is not limited thereto. Even an auxiliary chamber in which the volume thereof changes by a piston structure may be employed.

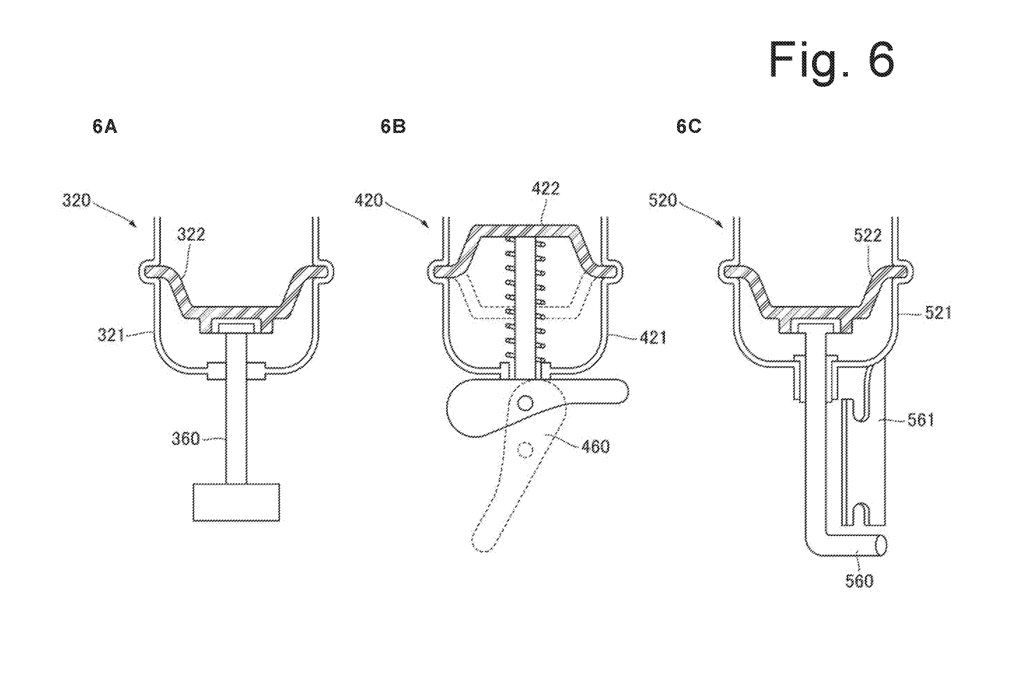

Furthermore, the operation lever to displace the displaceable film may employ a different configuration. For example, a tip of a screw 360 may be coupled to a displaceable film 322 so that rotation of the screw 360 can displace the position of the displaceable film 322 as shown in FIG. 6A. Alternatively, a leverage operation lever 460 connected to a displaceable film 422 may be used as shown in FIG. 6B. Alternatively, it is possible to employ a configuration including a securing plate 561 capable of stabilizing the position of a rod 560 connected to a displaceable film 522 in a stepwise manner as shown in FIG. 6C.

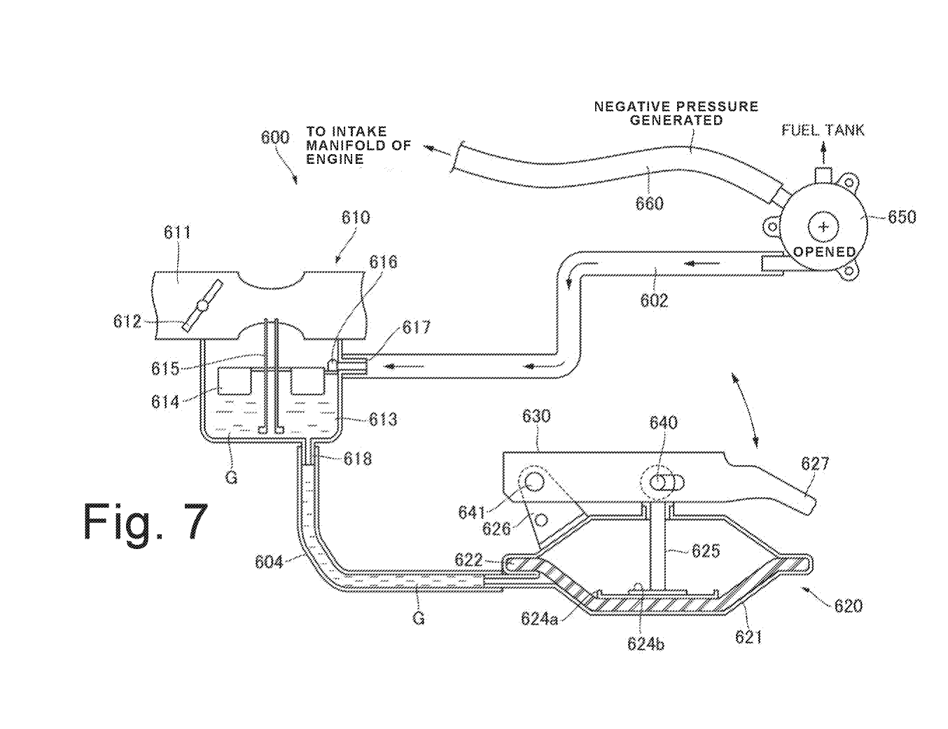

Subsequently, with reference to the accompanying drawings (FIGS. 7-11), a mechanism 600 for preventing fixation of a carburetor, as another exemplary embodiment of the present invention, will be described.

### Configuration of Mechanism 600 for Preventing Fixation of Carburetor

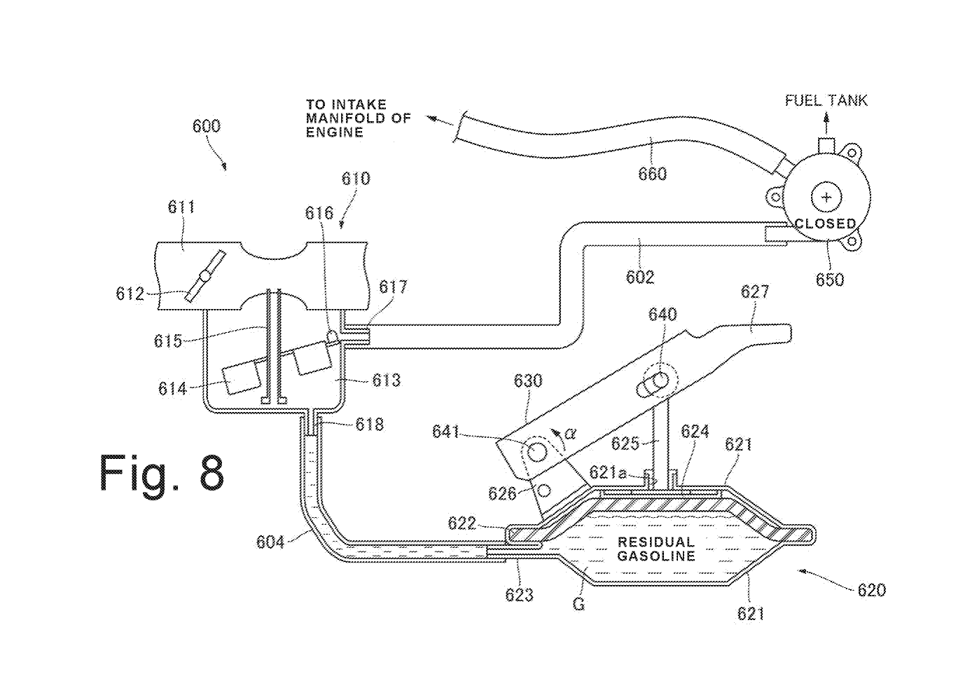

As shown in FIGS. 7 to 8, the mechanism 600 for preventing fixation of a carburetor, which is illustrated as an exemplary embodiment of the present invention, functions with an auxiliary chamber 620 connected to a carburetor 610 and a negative pressure type fuel cock 650, being used as main components. Although not illustrated in the figures, the carburetor 610 and the auxiliary chamber 620 are included in an internal combustion engine.

The carburetor 610 is provided along an air passage 611 through which intake air passes from an air cleaner (not shown) to a combustion chamber (not shown). A throttle 612 is provided in the air passage 611. The carburetor 610 is configured such that a float chamber 613 including a float 614 is attached below the air passage 611. Part of the air passage 611 has a venturi portion having a reduced diameter. A jet needle 615 extending from the float chamber 613 is disposed in such a manner that its head pierces through the venturi portion. An upper portion of a side surface of the float chamber 613 is provided with a float chamber fuel feed port 617. A fuel cock 650 is connected to the float chamber fuel feed port 617. The fuel cock 650 is connected to the float chamber 613 by a fuel pipe 602. The fuel cock 650 is also connected to a fuel tank (not shown). In other words, when the fuel cock 650 is opened, fuel flows into the float chamber 613 via the fuel pipe 602. When an appropriate amount of the fuel is accumulated in the float chamber 613, a valve 616 included in the float 614 blocks the float chamber fuel feed port 617 to stop the inflow of the fuel. The fuel cock 650 is connected by a negative pressure transmission pipe 660 to the intake pipe (intake manifold) of the internal combustion engine, and is configured such that the fuel cock 650 is opened with a predetermined negative pressure generated in the negative pressure transmission pipe 660 and is closed without a predetermined negative pressure being generated.

A float chamber fuel evacuation port 618 is provided at a bottom surface of the float chamber 613. A fuel pipe 604 is connected to the float chamber fuel evacuation port 618, and the other end of the fuel pipe 604 is connected to a connection port 623 of the auxiliary chamber 620.

The auxiliary chamber 620 is provided with what is called a displaceable film (diaphragm) 622, and capable of changing its volume by operations of the displaceable film 622. The exterior of the auxiliary chamber 620 is formed by a casing 621 having suitable stiffness, and residual fuel G can be introduced into the casing 621. The displaceable film 622 is included in the casing 621. An outer periphery of the displaceable film 622 is secured to the casing 621. A portion of the displaceable film 622 excluding the outer periphery, on the other hand, is not secured to the casing 621, and is therefore capable of displacement in the vertical direction. In other words, the inside of the casing 621 is separated into upper and lower two chambers by the displaceable film 622. The lower chamber is provided with the connection port 623 and communicated with the float chamber 613 via the fuel pipe 604.

A through hole 621a is provided at the approximately center of an upper surface of the casing 621, and a bias rod 625 is passed through the through hole 621a. A bias plate 624 is attached to the lower end of the bias rod 625. The bias plate 624 is further secured to the displaceable film 622 by bonding. In other words, when the bias rod 625 moves up and down, the displaceable film 622 is displaced up and down accordingly.

An upper end of the bias rod 625 is connected to an approximate center of an operation lever 627 via a pin 640. One end of the operation lever 627 is pivotally supported by a pivot support base 626 secured to the casing 621 via a pin 641. In other words, when the operation lever 627 is pushed upward, the displaceable film 622 is raised via the bias rod 625, thus increasing the volume of the auxiliary chamber 620. When the operation lever 627 is pushed downward, on the other hand, the displaceable film 622 is lowered via the bias rod 625, thus decreasing the volume of the auxiliary chamber 620. In this case, it is also possible to adopt a configuration in which a small space is provided between the displaceable film 622 and the casing 621 even when the displaceable film 622 is lowered. This can prevent fixation (fixation between the displaceable film 622 and the casing 621) due to altered gasoline.

### Effects and Functions of Mechanism 600 for Preventing Fixation of Carburetor

On the basis of the assumption that the previously-used residual fuel G in the float chamber 613 has been evacuated into the auxiliary chamber 620, operations will be sequentially described.

Operation Procedure when Internal Combustion Engine is Started

To start the internal combustion engine, the fuel cock 650 needs to be opened, but since the fuel cock in the present invention is of a negative pressure type, no particular operation is required.

In view of this, the operation lever 627 of the auxiliary chamber 620 needs to be pushed downward as shown in FIG. 7, thereby pushing out the previous residual fuel G in the auxiliary chamber 620 toward the float chamber 613.

Thereafter, when the internal combustion engine is started manually or by a starter, a negative pressure is generated on the intake pipe side by the movement. The generated negative pressure is transmitted to the fuel cock 650 through the negative pressure transmission pipe 660 to open the fuel cock 650 and supply fuel to the float chamber 613.

Operation Procedure when Internal Combustion Engine

An operation for evacuating the residual fuel G in the float chamber 113 into the auxiliary chamber 120 after the internal combustion engine is stopped will be described next.

When the internal combustion engine is stopped, the negative pressure of the negative pressure transmission pipe 660 disappears (or decreases) in conjunction therewith, so that the fuel cock 650 is closed and the supply of fuel from the fuel tank to the float chamber 613 is stopped. On the other hand, unvaporized residual fuel G remains in the float chamber 613, and if it is left as it is, alteration or the like of the residual fuel may cause a failure such as clogging of the jet needle 615. Therefore, pulling up the operation lever 627 can evacuate the residual fuel G in the float chamber 613 toward the auxiliary chamber 620.

As described above, in the present invention, the auxiliary chamber 620 capable of changing its volume within a given range is provided separately from the fuel tank; the auxiliary chamber 620 and the float chamber 613 of the carburetor 610 are communicated with each other; the fuel in the float chamber 613 can be sucked and temporarily evacuated, as needed, by increasing the volume of the auxiliary chamber 620; the temporarily evacuated fuel can be returned into the float chamber 613, as needed, by decreasing the volume of the auxiliary chamber 620; and the fuel cock 650 configured to control the supply of the fuel from the fuel tank to the carburetor 610 is of a negative pressure type in which the supply of the fuel is controlled by the negative pressure, and then the negative pressure transmission pipe 660 configured to communicate the fuel cock 650 and the intake pipe of the internal combustion engine with each other is provided.

The employment of such a configuration can temporarily extract the altered residual fuel from the float chamber 613 without returning to the fuel tank. In addition, since the fuel in the float chamber 613 is sucked to the auxiliary chamber 620 by utilizing the negative pressure generated by changing the volume of the auxiliary chamber 620, the residual fuel can be reliably extracted from the float chamber 613. Further, the negative pressure type fuel cock 650 is adopted, and the fuel cock 650 and the intake pipe are communicated with each other by the negative pressure transmission pipe 660. That is, the mechanism is configured such that the fuel cock 650 is opened and the fuel is supplied to the float chamber 613 when the negative pressure is generated in the intake pipe (in the state in which the internal combustion engine is being driven), and the fuel cock 650 is closed and the supply of the fuel to the float chamber 613 is stopped when the negative pressure is not generated in the intake pipe (in the state in which the internal combustion engine is not driven). In short, since the supply of the fuel to the float chamber 613 is automatically stopped when the internal combustion engine stops, it is possible to prevent the fuel from being further supplied to the float chamber 613 after the residual fuel in the float chamber 613 is transferred into the auxiliary chamber 620 subsequent to the stopping of the internal combustion engine.

Although not shown, it is also possible to configure the auxiliary chamber integrally with the float chamber. More specifically, for example, an auxiliary chamber is provided below the float chamber (as compared to the aforementioned embodiment, the auxiliary chamber is integrally formed upside down), and the residual fuel in the float chamber is transferred into the auxiliary chamber by lowering the displaceable film.

In this manner, the auxiliary chamber is formed not as a separate chamber but integrally with the float chamber in such a manner as to extend the float chamber downward. Consequently, similar effects (to those of the above-described mechanism 600 for preventing fixation of a carburetor) can be obtained, and a simpler and more compact configuration can be achieved also as a mechanism.

While the example in which the displaceable film (diaphragm) is used to change the volume of the auxiliary chamber has been described above, the auxiliary chamber is not limited thereto. For example, an auxiliary chamber in which the volume thereof changes by a piston structure may be employed.

Furthermore, the operation lever for displacing the displaceable film is not limited to the above-described embodiment, and a different configuration can be adopted.

Configuration of Second Embodiment with Atmosphere Open Valve

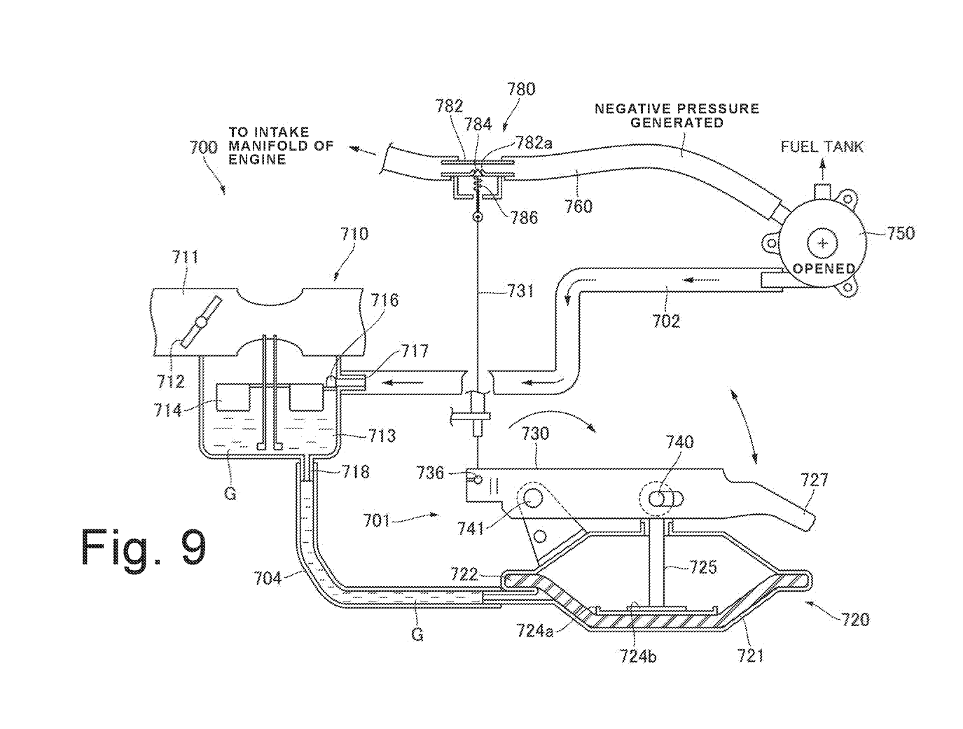

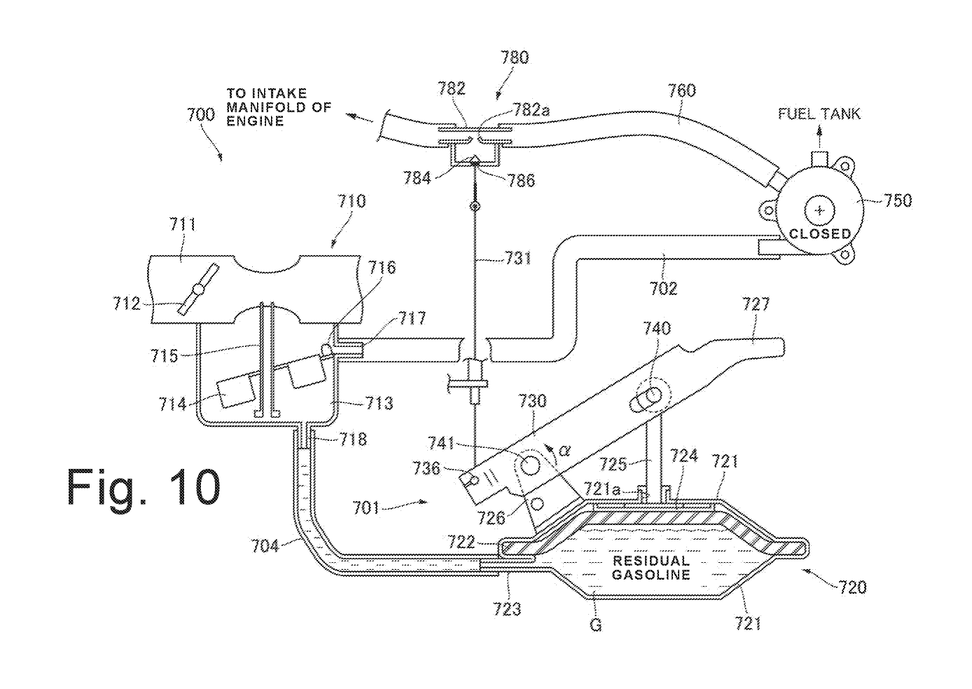

Next, as shown in FIGS. 9 to 10, a mechanism 700 for preventing fixation of a carburetor including an atmosphere open valve 780 will be described as a second embodiment. Note that parts that are the same as or similar to those of the mechanism 600 for preventing fixation of a carburetor described above are denoted by the same numerals for the last two digits, and a duplicate description thereof will be omitted, and different parts will be mainly described below.

The mechanism 700 for preventing fixation of a carburetor differs from the mechanism 600 for preventing fixation of a carburetor described above in that an atmosphere open valve 780 is provided along the negative pressure transmission pipe 760, and a negative pressure shutoff mechanism 701 mechanically connected by a wire 731 to the atmosphere open valve 780 and an operation lever (operation unit) 727 of the auxiliary chamber 720 is provided.

The atmosphere open valve 780 is provided with a release hole 782a in its main body portion 782, and a plug body 784 is constantly biased against the release hole 782a by the negative force of a spring 786, so that the sealing property of the inside is maintained. The plug body 784 is connected to one end of the operation lever 727 via a wire attachment portion 736 by a wire 731. As a result, when the operation lever 727 is located at a first position (in the state of FIG. 9) in which the volume of the auxiliary chamber 720 is reduced and the fuel is present in the float chamber 713, the atmosphere release valve 780 is closed (i.e., the plug body 784 is in contact with the release hole 782a), and thus, the negative pressure generated in the intake pipe is transmitted to the fuel cock 750 through the negative pressure transmission pipe 760. On the other hand, when the operation lever 727 is located at a second position (in the state of FIG. 10) in which the volume of the auxiliary chamber 720 increases and the fuel is evacuated from the float chamber 713, the atmospheric open valve 780 is opened (i.e., the plug body 784 is not in contact with the release hole 782a), and thus, the negative pressure generated in the intake pipe is blocked to the extent that at least the fuel cock 750 is closed (i.e., the negative pressure is blocked by the inflow of atmospheric air from the atmospheric open valve 780 into the negative pressure transmission pipe 760).

Such a configuration can automatically block the negative pressure of the negative pressure transmission pipe 760 by operating the operation lever (operation unit) 727 of the auxiliary chamber 720 and close the fuel cock 750. That is, when the operation lever 727 is at the first position (when the fuel is present in the float chamber 713), the negative pressure in the negative pressure transmission pipe 760 transmitted from the intake pipe is transmitted to the fuel cock 750 without any obstacle, so that the fuel cock 750 is opened and the fuel is supplied to the float chamber 713. On the other hand, when the operation lever 727 is at the second position (when the fuel is not present in the float chamber 713), the negative pressure in the negative pressure transmission pipe 760 is blocked by the inflow of the atmosphere from the atmosphere release valve 780. That is, the fuel cock 750 is closed, and the fuel supply to the float chamber 713 is stopped. Therefore, even if the operation lever 727 of the auxiliary chamber 720 is operated (the operation for transferring the fuel of the float chamber 713 into the auxiliary chamber 720) in a state in which the internal combustion engine is not stopped (in a state in which the internal combustion engine is being driven), the fuel can be reliably prevented from being continuously supplied to the float chamber 713. Further, since the supply of fuel itself is stopped by the operation of the operation lever 727, the mechanism can serve also a mechanism configured to stop the internal combustion engine.

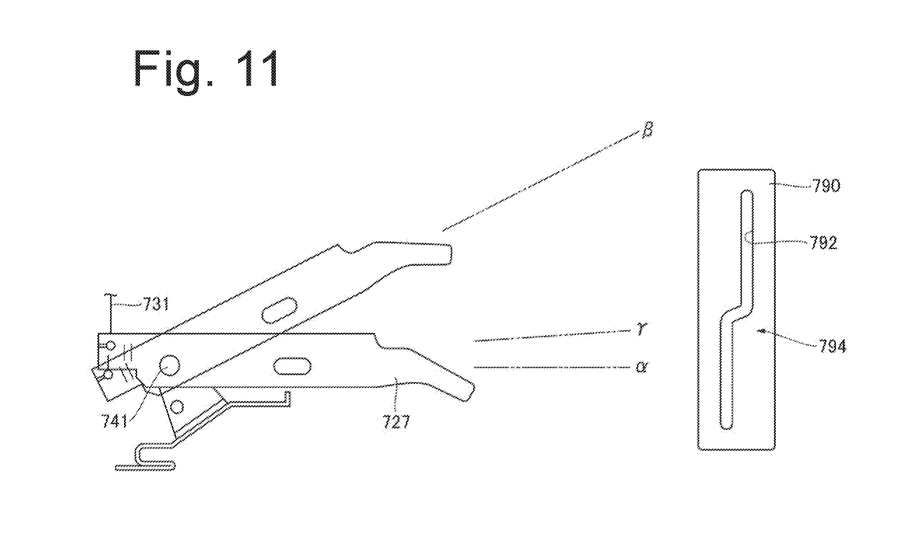

As schematically shown in FIG. 11, it is desirable to provide a change point γ at which the opening and closing of the fuel cock 750 changes is provided in the middle of the transition of the operation lever 727 from the first position α to the second position β, and further to provide a delay unit configured to delay the time during which the operation lever 727 shifts from the change point γ to the second position β.

In this manner, it (the opening of the atmosphere open valve 780) is adjusted so as to change the opening and closing of the fuel cock 750 in the middle of the transition of the operation lever 727 from the first position α to the second position β. Thus, the fuel is more reliably prevented from being supplied to the float chamber 713 after the residual fuel G is evacuated to the auxiliary chamber 720, and the fuel is prevented from overflowing from the float chamber 713 when the fuel evacuated to the auxiliary chamber 720 is returned to the float chamber 713 at the time of restart. At this time, making the position of the change point γ as close as possible to the first position α can further reduce the amount of fuel that can be supplied until the operation lever 727 reaches the change point γ. Further, providing the delay unit can continue the operation of moving the operation unit 727 to the second position even after the supply of the fuel is stopped. Thus, the fuel unintentionally having been supplied to the float chamber 713 can be transferred to the auxiliary chamber 720 with reducing the remaining fuel as much as possible in the float chamber 713.

The above-mentioned delay unit can also be realized by setting the change point γ to a position as close as possible to the first position α. Such a configuration can configure the delay unit without separately providing any other part or mechanism. That is, since “the change point γ is close to the first position α” means that “the change point γ is far from the second position β” at the same time, the delay unit is constituted by this physical distance.

Also, as shown in FIG. 11, a guide unit 790 having a guide groove 792 with which a portion of the operation lever 727 is fitted and by which its movement is guided may be provided, and the delay unit may be formed by a configuration in which, for example, a crank portion 794 is provided along the guide unit (in the middle of transition from the change point γ to the second position β).

Although not shown, the delay unit may be configured by making the operation load of the operation lever 727 from the change point γ to the second position β larger than the operation load of the operation lever 727 from the first position α to the change point γ. At this time, the load may be variable.

With such a configuration, the operation needs to be moved in a crank-like or hook-like manner when the operation lever 727 is operated from the change point γ to the second position β, so that the operation is delayed by the time required for this movement.

1. A mechanism for preventing fixation of a carburetor, wherein
an auxiliary chamber capable of changing a volume thereof within a given range is provided separately from a fuel tank,
the auxiliary chamber and a float chamber of a carburetor are communicated with each other,
fuel in the float chamber can be sucked and temporarily evacuated, as needed, by increasing the volume of the auxiliary chamber, and
the temporarily evacuated fuel can be returned into the float chamber, as needed, by decreasing the volume of the auxiliary chamber.

2. A mechanism for preventing fixation of a carburetor, wherein
an auxiliary chamber capable of changing a volume thereof within a given range is provided separately from a fuel tank,
the auxiliary chamber and a float chamber of a carburetor are formed integrally with each other,
fuel in the float chamber can be temporarily evacuated, as needed, by increasing the volume of the auxiliary chamber, and
the temporarily evacuated fuel can be returned into the float chamber, as needed, by decreasing the volume of the auxiliary chamber.

3. The mechanism for preventing fixation of a carburetor according to claim 1, further comprising a structure for preventing an incorrect operation, wherein
the structure includes an operation unit configured to change the volume of the auxiliary chamber, the operation unit changing a position thereof in accordance with a change in the volume of the auxiliary chamber,
the operation unit is mechanically coupled to a fuel cock configured to control supply of fuel from the fuel tank to the carburetor, and
the fuel cock can be opened and the fuel can thus be fed into the float chamber from the fuel tank only while the operation unit is at a position to decrease the volume of the auxiliary chamber and thus return the fuel to the float chamber.

4. The mechanism for preventing fixation of a carburetor according to claim 3, wherein
the mechanism for preventing an incorrect operation is further characterized in that the fuel in the float chamber can be introduced into the auxiliary chamber by operating the operation unit only in a state in which the fuel cock is closed.

5. The mechanism for preventing fixation of a carburetor according to claim 1, wherein
the fuel cock configured to control the supply of the fuel from the fuel tank to the carburetor is of a negative pressure type in which the supply of the fuel is controlled by a negative pressure, and
the mechanism for preventing fixation of a carburetor further comprises a negative pressure transmission pipe configured to communicate the fuel cock and the intake pipe of the internal combustion engine with each other.

6. The mechanism for preventing fixation of a carburetor according to claim 5, further comprising:
a mechanism for blocking a negative pressure including an operation unit configured to change the volume of the auxiliary chamber, the operation unit changing a position thereof in accordance with a change in the volume of the auxiliary chamber, wherein
an atmosphere release valve capable of communicating the inside and the outside of the negative pressure transmission pipe is provided along the negative pressure transmission pipe,
the operation unit is mechanically coupled to the atmosphere open valve,
the mechanism for blocking a negative pressure is capable of transmitting a negative pressure generated in the intake pipe to the fuel cock via the negative pressure transmission pipe while the atmosphere release valve is closed when the position of the operation unit is at a first position where the fuel is present in the float chamber by reducing the volume of the auxiliary chamber, and blocking a negative pressure generated in the intake pipe to the extent that the fuel cock is closed when the atmospheric open valve is opened at a second position where the fuel is evacuated from the float chamber while the volume of the auxiliary chamber is increased.

7. The mechanism for preventing fixation of a carburetor according to claim 6, wherein
a change point at which the opening and closing of the fuel cock changes is provided in a middle of transition of the operation unit from the first position to the second position, and
a delay unit configured to delay the time during which the operation unit shifts from the change point to the second position is provided.

8. The mechanism for preventing fixation of a carburetor according to claim 7, wherein
the delay unit is realized by setting the change point as close as possible to the first position.

9. The mechanism for preventing fixation of a carburetor according to claim 7, wherein
the delay unit is realized by providing a guide unit configured to guide a movement of the operation unit at the time of transition from the first position to the second position, and configuring a shape guided by the guide unit in a crank shape or a hook shape in the middle of the transition of the operation unit from the change point to the second position.

10. The mechanism for preventing fixation of a carburetor according to claim 7, wherein
the delay unit is realized by making an operation load on the operation unit from the change point to the second position larger than an operation load on the operation unit from the first position to the change point.

11. A carburetor comprising the mechanism for preventing fixation of a carburetor according to claim 3.

12. An internal combustion engine comprising the carburetor according to claim 11.

13. The mechanism for preventing fixation of a carburetor according to claim 2, further comprising a structure for preventing an incorrect operation, wherein
the structure includes an operation unit configured to change the volume of the auxiliary chamber, the operation unit changing a position thereof in accordance with a change in the volume of the auxiliary chamber,
the operation unit is mechanically coupled to a fuel cock configured to control supply of fuel from the fuel tank to the carburetor, and
the fuel cock can be opened and the fuel can thus be fed into the float chamber from the fuel tank only while the operation unit is at a position to decrease the volume of the auxiliary chamber and thus return the fuel to the float chamber.

14. The mechanism for preventing fixation of a carburetor according to claim 2, wherein
the fuel cock configured to control the supply of the fuel from the fuel tank to the carburetor is of a negative pressure type in which the supply of the fuel is controlled by a negative pressure, and
the mechanism for preventing fixation of a carburetor further comprises a negative pressure transmission pipe configured to communicate the fuel cock and the intake pipe of the internal combustion engine with each other.

15. A carburetor comprising the mechanism for preventing fixation of a carburetor according to claim 5.

16. An internal combustion engine comprising the carburetor according to claim 15.
